(19) United States
(12) Patent Application Publication
(10) Pub. No.: US 2026/0086110 A1
(43) Pub. Date: Mar. 26, 2026

(54) EXTENSION OF A CIRCUIT FOR INERTIAL SENSORS FOR THE DETECTION, CALIBRATION AND DYNAMIC CORRECTION OF SQUEEZE FILM DAMPING AND RESTORING EFFECTS DURING HIGH-LOAD OPERATION

(71) Applicant: Robert Bosch GmbH, Stuttgart (DE)

(72) Inventors: Juergen Mueller, Ofterdingen (DE); Lukas Ackermann, Reutlingen (DE); Akos Szabo, Budapest (HU)

(21) Appl. No.: 19/330,274

(22) Filed: Sep. 16, 2025

(30) Foreign Application Priority Data
Sep. 20, 2024 (DE) 10 2024 209 042.5

(51) Int. Cl. G01P 21/00; G01P 15/08; G01P 15/125; G01P 15/135

(52) U.S. Cl. CPC G01P 21/00; G01P 15/125; G01P 15/135; G01P 2015/0871; G01P 2015/0882

(57) ABSTRACT

A micromechanical inertial sensor having a sensor element movably arranged in a cavity. The sensor includes a detection device for detecting a transient measurement signal depending on a deflection of the sensor element along a detection direction from a starting position. The detection device is configured to detect comparatively small up to geometric full deflections of the sensor element parallel to the detection direction. The detection device is configured to effect a comparatively large mechanical deflection of the sensor element parallel to the detection direction in a test mode and has a first electrode structure. The first electrode structure is arranged opposite the sensor element along the detection direction such that between the sensor element and the first electrode structure and by means of an applied electrical voltage, a variable capacitance is formed. A gaseous medium is located in the cavity, which medium influences movements of the sensor element.

### CROSS REFERENCE

The present application claims the benefit under 35 U.S.C. § 119 of Germany Patent Application No. DE 10 2024 209 042.5 filed on Sep. 20, 2024, which is expressly incorporated herein by reference in its entirety.

### FIELD

The present invention is based on a sensor system, e.g. a micromechanical inertial sensor. The calibrated operation of such systems as measuring systems requires knowledge of the characteristic values of the included electrical components (electrodes, electronic circuitry, springs, masses) and also of the mechanisms that cause damping: e.g., gas pressures in the sensor volume that cause friction and dissipation.

### BACKGROUND INFORMATION

Such micromechanical inertial sensors are often operated to their physical and geometric limits in terms of their functionality in order to achieve the most efficient operation and the largest possible measuring range. Accordingly, the functional design of the micromechanical inertial sensors is designed or conceived in such a way that they can be used up to the physical limits of their functionality. Examples of this include applications or scenarios that cause a comparatively large deflection of the sensor element in the cavity. In particular, shock-type applications or scenarios are typical fields (of application) in which such a comparatively large deflection is generated (in a shock-like manner).

The so-called pull-in effect, which is very important in this context, represents a serious limitation of the characterization options according to the related art. The pull-in effect limits the range of static and dynamic small-signal characterization of the sensor systems to about ⅓ of the sensor actuation range and thus also of the detectable measuring range. In the context of shock-type scenarios, it is important for the micromechanical inertial sensor to provide reliable data and to keep the risk of exceeding the physical limits (i.e., the occurrence of damage to or within the micromechanical inertial sensor) as low as possible. In the context of direct test or characterization measurements, comparatively large deflections of the sensor element, such as those occurring in such a shock-type scenario, are difficult to produce (i.e., without causing damage). Therefore, very little data and information from direct test or characterization measurements are available. Alternatively, however, only indirect information or data are available, which cannot be used specifically for characterization purposes, or can only be so used to a limited extent.

All this therefore has the disadvantage that comparatively few properties can be characterized for comparatively large deflections, in particular for a specific manufactured micromechanical inertial sensor. This is particularly disadvantageous in the automotive sector, as shock-type applications and scenarios are encountered more often there and, accordingly, a direct characterization of these comparatively large deflections would be advantageous.

The damping properties of the system are very important for a correct sensor reading and its conversion into a correct sensor output value. In particular, the sensor properties depending on the frequency spectrum of the applied signal are strongly dependent on the damping characteristics.

Lack of knowledge of the exact properties leads to misinterpretation of the stimulus to be measured or, preventively, to a limitation of the permissible range of application of the sensor.

The gap in knowledge and characterization currently has the result that the systems cannot be used in the fundamentally calculable and thus calibratable range, which usually leads to a preventive restriction of the application specification.

Furthermore, there is also a relevance of or need for characterization of the cavity, in particular with regard to its hermetic sealing. In the event of a leak within the hermetic seal of the cavity, the gaseous medium located in the cavity escapes and the pressure inside the cavity adapts to the external pressure. This has the major disadvantage that the gaseous medium or the pressure within the cavity is very precisely tailored to the functionality of the sensor and therefore a leak represents a major disruption to the functionality of the sensor. There is therefore a need to check the hermetic sealing both during production and also, in addition, in the context of the micromechanical inertial sensor to be put into operation. Direct measurements in this regard are difficult to realize, and there is therefore a need for an effective and efficient design of a micromechanical inertial sensor for checking the hermetic sealing of the cavity.

### BACKGROUND INFORMATION

An object of the present invention is to provide a micromechanical inertial sensor having a sensor element movably arranged in a cavity, which does not have the disadvantages mentioned above, in particular due to its design.

The high-load conditions arising during real-world operation with regard to damping effects should also be detectable during the characterization run and during the life cycle by lifetime retest, so that a correct calibration of the sensor output can be achieved during operation. Knowledge of the properties that can be detected in this way also allows preventive countermeasures to avoid structural damage and an extension of the specifiable range of application.

The device and the equipment extension of the present invention described herein allow measurements of the damping properties in an “overpressure” condition that is not yet accessible according to the related art. This condition allows a much more precise detection of even slight changes in the damping state and thus in the gas density and hermetic tightness of the components.

Advantageous embodiments and developments of the present invention can be found in the disclosure therein.

According to an advantageous embodiment of the present invention, the micromechanical inertial sensor is configured such that when a static voltage above a pull-in voltage is applied, the influence of the gaseous medium in the region between the sensor element and the first electrode structure and/or in the region between the sensor element and a second electrode structure is detected with the aid of the measurement signal. The measurement signal can be detected using the usual electronic sensor readout mechanisms, as in normal operation. In normal operation, reduced application bandwidths are common, which are usually achieved through downstream digital processing. For the test mode, sufficient bandwidth is required for the detection of the pulse-type pull-in sequences. A sufficiently broadband electronic front end is therefore implemented for the signal recording. Typical values are 5 to 15 kHz, in order to capture the details of the pull movement sequence.

According to an advantageous embodiment of the present invention, the influence of the gaseous medium, in particular a damping effect, in a further region within damping structures can be detected and stored, wherein the damping structures are formed geometrically separately from the sensor element, the first electrode structure and/or the second electrode structure, wherein the damping structures are directly coupled to a movement state of the sensor element. In this case, too, squeeze film formation occurs, which can be analyzed completely analogously using the device described here.

According to an advantageous embodiment of the present invention, square-wave voltages of variable pulse height can be applied as an additional test signal to the readout signal. According to the related art, such test signals with small voltage swings are common. However, the maximum voltages are limited to values below typical pull-in voltages (greater than 2V) by the reference voltages (stabilized bandgap voltages) of the ASIC technology used. Going beyond the related art, the system is extended in such a way that such higher voltages (2 to 10V, possibly higher) can be provided and applied by the electronic circuit in addition to the normal signal detection.

According to an advantageous embodiment of the present invention, stop structures are positioned between the sensor element and the first electrode structure and/or between the sensor element and the second electrode structure, wherein the sensor element can be deflected at most up to the positioning of the stop structures.

According to an advantageous embodiment of the present invention, the micromechanical inertial sensor is configured in such a way that the influence of the gaseous medium can be detected by the action of a test voltage for triggering large-scale movement sequences and recording using the sensor readout principle. The influence of the damping medium is described by a modeling function motivated by physical theory. In a simple case, this can be modeled as a sum of a constant and a product of another constant with the fourth power of a deflection of the sensor element.

According to an advantageous embodiment of the present invention, the micromechanical inertial sensor is configured such that the influence of the gaseous medium can be characterized using a compensation calculation based on the deflection of the sensor element and the measurement signal generated and stored by the sensor element, wherein the compensation calculation is carried out in particular on the basis of the temporal behavior or course of the deflection and the temporal behavior of the stored movement sequence.

According to an advantageous embodiment of the present invention, a sampling rate at which the measurement signal is detected lies in a range far above the sensor's natural frequencies (kHz to 10 kHz), for example in the range from 100 to 1000 kHz, so that the movement sequence to be characterized is not influenced by the imposed readout pattern.

According to an advantageous embodiment of the present invention, a recording of the movement curves is supplemented by an additional memory. The write rate of the memory is typically at least in the range of 20 to 100 kHz in order to capture the necessary signal frequencies for the evaluation at a sufficiently high frequency. The memory length is at least in the range of a few milliseconds in order to capture typical large-signal courses (e.g. pull-in movements). In a variant of the method, the memory depth is much more extensive, e.g. in the range of 100 ms, in order to record a long sequence of signal transients actuated in the same way. The purpose of this variant is to overlay the individual signals of the sequence, e.g. with averaging, and thus ensure a better signal-to-noise ratio.

A further subject matter of the present invention is a method for operating a micromechanical inertial sensor having a sensor element movably arranged in a cavity.

The advantages and designs that have been described in connection with the embodiments of the present invention of micromechanical inertial sensor having a sensor element movably arranged in a cavity according to the present invention can be used for the method of the present invention for operating a micromechanical inertial sensor having a sensor element movably arranged in a cavity.

Exemplary embodiments of the present invention are illustrated in the figures and explained in more detail in the following description.

### BRIEF DESCRIPTION OF THE DRAWINGS

FIG. 1 shows a schematic representation of a sensor element movably arranged in a cavity of a micromechanical inertial sensor in a starting position, according to an example embodiment of the present invention.

FIG. 2 shows a schematic representation of a sensor element movably arranged in a cavity of a micromechanical inertial sensor, strongly deflected from a starting position, according to an example embodiment of the present invention.

FIG. 3 shows a modeling of an influence of a gaseous medium located in the cavity depending on a deflection of the sensor element, according to an example embodiment of the present invention.

FIGS. 4A and 4B each show temporal courses of an applied electrical voltage and temporal courses of a deflection of a sensor element according to an example embodiment of the present invention for two forms of the damping medium.

### DETAILED DESCRIPTION OF EXAMPLE EMBODIMENTS

The method and the equipment extension described here allow measurements of the damping properties in an “overpressure” condition that is not yet accessible according to the related art. This condition allows a much more precise detection of even slight changes in the damping state and thus in the gas density and hermetic tightness of the components.

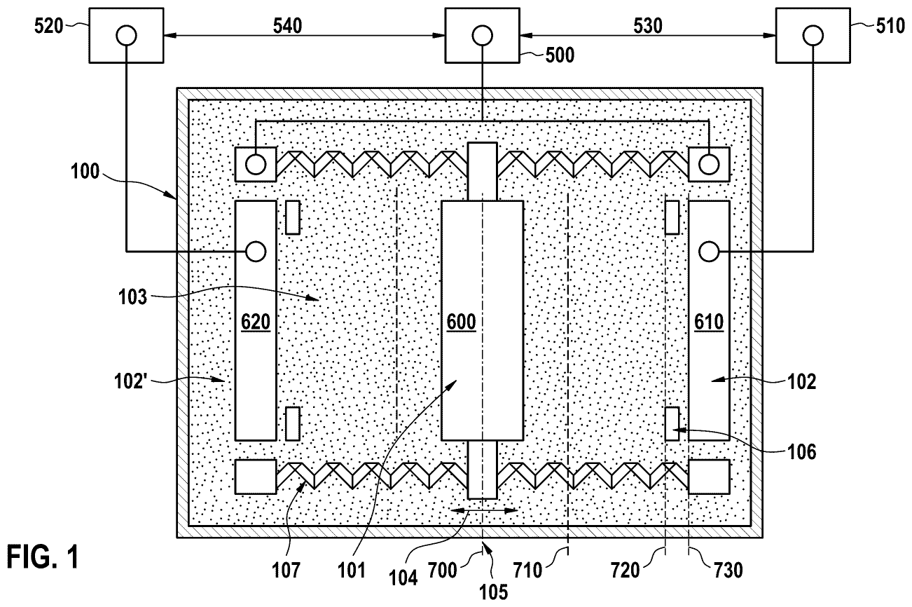

The basic sensor principle is explained below. FIG. 1 provides a very good illustration of the following summary.

Inertial sensors have an inertial mass m in a spring-mass damping system and an electronic evaluation circuit. In the simplest case, the dynamics in the sensor's reference system are described by the following Newtonian equation of motion:

$$m \cdot \ddot{x} + k \cdot x + d ( x ) \cdot \dot{x} = - m \cdot {a}_{ext} ( t ) + {F}_{setup} ( U , t ) \qquad EQ . 1$$

Normal sensor operation is intended to detect the external acceleration aₑₓₜ(t) and to output it in a calibrated manner. For this purpose, an electronic circuit (setup) is used, which, however, must only have a negligible influence on the measuring process (Fₛₑₜᵤₚ(U,t)→0).

‘Normal’ operation consists in the detection of constant or slowly varying external accelerations (=quasi-static conditions:

$${a}_{ext} = {a}_{{exit}^{′}}^{c}$$

\dot{x}≈0 and consequently also \ddot{x}≈0) at each point in time the sensor assumes a static deflection, which by the external acceleration according to the basic equation
EQ. 1, where external acceleration and spring return (Hook's constant k) come into equilibrium:

$${a}_{ext}^{c} = - k / m \cdot x \qquad EQ . 2$$

By measuring the deflection, the acceleration can thus be calculated for known system variables k and m. The moving mass m of the system is connected to electrode surfaces, which usually form differential capacitors with other electrode elements of the system.

The measurement of the deflection x is carried out using electronic circuits that make capacitance measurement variables

$$Δ C = {C}_{M - C 1} - {C}_{M - C 2} ( ⋆ ) or Δ C / \sum C = \frac{( {C}_{M - C 1} - {C}_{M - C 2} )}{( {C}_{M - C 1} + {C}_{M - C 2} )} ( ⋆ ⋆ )$$

measurable. These measurement variables (ΔC* or ΔC/ΣC**) are proportional to the deflection x (for * approximately for small x<<d₀ and for ** also for larger deflections, although the capacitances themselves are non-linear variables of the type

$$C ( x ) = \frac{ε \cdot A}{{d}_{0} ∓ x} ) .$$

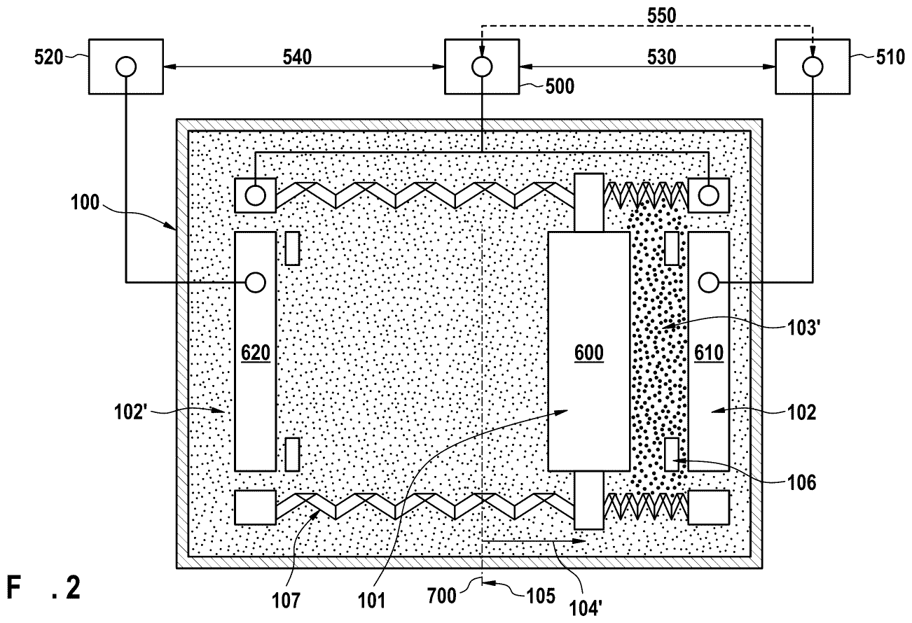

The theoretical operating range extends over the entire deflection range of the mass 600 or CM—in FIG. 1, from x=0 (in FIGS. 1 and 2 shown with the reference sign 700) up to the stop points 106 almost to the counter-electrode 610 or C1 (or 620 or C2), i.e. almost over the entire rest distance 730 or d₀.

Furthermore, the limitation of the characterization due to the pull-in effect is described below. The characterization of the sensor with regard to deflectability, restoring forces and the like is usually carried out using static electrical dummy stimuli or time-dependent, e.g. periodic electrical small-signal stimuli for dynamic characterization around static operating points, with the aid of the term Fₛₑₜᵤₚ(U,t) in m·x+k·x+d(x)·\dot{x}=−m·aₑₓₜ(t)+Fₛₑₜᵤₚ(U, t) EQ. 1 by the sensor electronics or a test setup.

To do this, first operating points are approached with static voltages (↔\ddot{x}=0, \dot{x}=0) and there results, with m·x+k·x+d(x)·\dot{x}=−m·aₑₓₜ(t)+Fₛₑₜᵤₚ(U, t) EQ. 1 and the formula for electrical forces between plate capacitances

$$F ( U ) = \frac{1}{2} \frac{ε \cdot A}{{( {d}_{0} - x )}^{2}} \cdot {U}^{2} :$$

$$k \cdot x = \frac{1}{2} \frac{ε \cdot \dot{A}}{{( {d}_{0} - x )}^{2}} \cdot {U}^{2} \qquad EQ . 3$$

The solution of this equation for x is only possible numerically for the general case, and a solution is only obtained up to a certain voltage value U_{PI} given by the spring strength and capacitance geometry, with a maximum deflection x_{PI} that can then be achieved.

$${U}_{PI} = \sqrt{\frac{4}{27} \cdot \frac{k}{ε \cdot A} \cdot {d}_{0}^{3}} and {x}_{PI} = \frac{1}{3} {d}_{0} \qquad EQ . 4$$

This means that almost ⅔ of the total usable range (of

$${x}_{PI} = \frac{1}{3} {d}_{0}$$

(shown in FIG. 1 with reference sign 710) to the stops 106) cannot be achieved by characterization experiments according to the related art.

Furthermore, the squeeze film effect is described below. Particularly in the area of large deflections, narrow spatial gaps form from which the gas of the sensor atmosphere can escape less easily (cf. zone 103′ in FIG. 2). This gives rise to an increase in the gas pressure in these zones and thus an increased damping effect on the moved sensor mass 600 or CM and also additional spring-type restoring forces.

The damping coefficient d=d(x) in m·x+k·x+d(x)·\dot{x}=−m·aₑₓₜ(t)+Fₛₑₜᵤₚ(U, t) EQ. 1 is therefore not constant, but rather has a very strong increasing characteristic d(x) with increasing deflection x.

This has a strong influence on the sensor properties, e.g. the sensitivity spectrum of the sensor over the frequency and amplitude of the acceleration stimulus. The strong counterpressure, for example, greatly reduces the sensitivity of the sensor in pulse situations.

However, these effects are not directly accessible using characterization methods from the related art. Special laboratory characterization experiments on so-called shaker and centrifuge devices are available. However, such experiments are limited to a small number of components, and the depth of analysis is greatly reduced due to the special design and the lack of analysis options (fast transient memories). In other words, auxiliary experiments are used, but their usefulness is low.

The deflection of the sensing element 600 or CM can be achieved, as described above, by applied static or pulse-like accelerations, wherein only in the second case does the application-relevant squeeze film form and lead to significant changes in the sensor behavior. The first case of static, constant acceleration is easily realizable experimentally (sensor in centrifuge with adjustable rotational speed, i.e. constant centrifugal force), but the squeeze film of interest for the application does not form.

By applying a voltage form U(t), e.g. a step with a final value that overcomes the pull-in point, the sensor can now however be brought into states similar to those in the application situation. This is shown in FIG. 2 (550 or test: U_{ReadOut}+U_{PI-Step} (>U_{PI})_┌). In particular, the squeeze film to be characterized forms. At the same time, the normal readout process can be carried out using the usual electrical circuitry (530, 540 or U_{ReadOut1/2}) so that the movement of element 600 or CM can continue to be detected and evaluated.

For this purpose, the electronic evaluation circuit is equipped according to the present invention with an additional storage device for the resulting movement sequence, which, for example, is recorded for the activation of the additional test voltage (550 or Test: U_{ReadOut}+U_{PI-Step}).

In this case, the recorded movement sequence up to the stop elements 106 is determined by the Newtonian motion (differential) equation and can also be calculated:

$$m \cdot \ddot{x} = - k \cdot x - d ( x ) \cdot x + \frac{1}{2} \frac{ε \cdot \dot{A}}{{( {d}_{0} - x )}^{2}} \cdot {U ( t )}^{2} \qquad EQ . 5$$

This corresponds to m·x+k·x+d(x)·\dot{x}=−m·aₑₓₜ(t)+Fₛₑₜᵤₚ(U, t)
EQ. 1, reproduced here again and explicitly supplemented with the force term

$$F ( U ( t ) , x ) = \frac{1}{2} \frac{ε \cdot A}{{( {d}_{0} - x )}^{2}} \cdot {U ( t )}^{2}$$

of the electrical stimulation via the sensor electrodes.

Due to the steeply increasing damping that occurs when the squeeze film scenario is reached, a location-dependent damping coefficient d(x) must also be included in this description equation instead of the constant d of the small-signal range. The above differential equation

$$m \cdot x = - k \cdot x - d ( x ) \cdot x + \frac{1}{2} \frac{ε \cdot \dot{A}}{{( {d}_{0} - x )}^{2}} \cdot {U ( t )}^{2}$$

EQ. 5 can be solved numerically by integration (initial value problem, ODE integration), if the involved structural and media variables spring constant, plate base distance 730 or do, plate area A and the x-dependent damping model d(x) and the time course of the electrical voltage U(t) are known.

By comparing the recorded measurement curve and the differential equation solution parameterized with a modeling curve d(x), the shape of the previously unknown damping characteristic can be determined by regression.

For this purpose, the evaluation circuit is given an additional arithmetic unit (e.g. a microcontroller or a neural network) which can evaluate the recorded curve using mathematical means or trained neuron coefficients. As in normal operation, the normal readout operation (530, 540 or U_{ReadOut1/2}) does not disturb the dynamic testing process.

FIG. 1 shows a schematic representation of a sensor element 101 movably arranged in a cavity 100 of a micromechanical inertial sensor, in a starting position 105 according to an embodiment of the present invention. Along a detection direction 104, a second electrode structure 102′, the sensor element 101 movably suspended on a spring in the starting position 105, and a first electrode structure 102 are arranged within the cavity 100 (from left to right). Both the first electrode structure 102 and the second electrode structure 102′ are arranged opposite the sensor element 101 along the detection direction 104 such that a variable capacitance is formed between the sensor element 101 and the first electrode structure 102 and a further variable capacitance is formed between the sensor element 101 and the second electrode structure 102′. A gaseous medium is also located in the cavity 100, which medium influences the movement of the sensor element 101. Furthermore, in this depicted preferred embodiment, stop structures 106 are positioned in the region 103 between the sensor element 101 and the first electrode structures 102 and 102′. The sensor element 101 can thus be deflected at most up to the positioning of the stop structures 106, or can be deflected only up to the positioning of the stop structures 106.

Furthermore, the micromechanical inertial sensor has a detection device for detecting a measurement signal depending on the deflection of the sensor element 101 along the detection direction 104 from the starting position 105 on both sides up to the positions 720 and x_{Max}. For this purpose, electrical signals are applied via contact pads 510 or P1, 520 or P2, 500 or PM, which, however, must not noticeably influence the mechanical movement process. This is indicated in the drawing of FIG. 1 by the reference signs 530 and 540 with the symbolic meaning R_{eadOut1/2}→≈0.

Inertial sensors are usually designed symmetrically so that accelerations in both directions can be detected via the sensor electrodes C2-CM-C1. To understand the designs, see for example the elements at the right in FIG. 1 and FIG. 2.

Furthermore, larger voltages can be applied via the contact pads, which can electrically pull the sensor into the stop elements 106 on both sides for testing purposes. This is indicated in FIG. 2 by the reference sign 550 or its symbolic meaning “(Test: U_{Readout1}+U_{PI-Step}(>U_{PI})_┌)” for actuation toward the right side.

In the above section on the related art, it was explained that using such voltages, only actuations of the sensor element 600 or CM up to the stops 106 can be realized (typical voltages are in the range of a few volts).

However, in stable positions of, for test purposes, only in one-third of the rest distance 730 or do are possible. This region stably approachable in the test is shown in FIG. 1 as a dashed line on both sides around the rest position.

The region beyond this is the so-called pull-in region, in which no statically accessible equilibrium positions exist.

If voltages higher than the pull-in voltage are applied, the sensor moves with increasing acceleration over the static zone (710 or d₀/3) and comes to rest only upon reaching the stop elements 106.

The majority of the region outside of zone 710 or the d₀/3 zone is therefore inaccessible for static tests and small-signal tests around static operating points, according to the related art.

According to the present invention, the micromechanical inertial sensor is configured such that, using the additional test voltage shown in FIG. 2, a comparatively large deflection of the sensor element 101 along the detection direction 104 can be realized such that an influence of the gaseous medium in the region 103 between the sensor element 101 and the first electrode structure 102 can be detected with the aid of the measurement signal. The normal readout voltages 530 or U_{Readout1} and 540 or U_{Readout2} are still present in this so-called test mode on the pads 510 or P1, 520 or P2, 500 or PM, and thus also at the electrodes 610 or C1, 620 or C2, 600 or CM, and bring about the precise quantitative detection of the sensor deflection, as in normal operation.

FIG. 2 shows a schematic representation of a sensor element 101 movably arranged in a cavity 100 of a micromechanical inertial sensor, deflected from a starting position 105 along the detection direction 104 according to an embodiment of the present invention. The sensor element 101 is deflected (in a shock-like manner) comparatively far from the starting position 105 in the direction of the first electrode structure 102, parallel to the detection direction 104, by the applied electrical test voltage (cf. the reference signs in FIG. 2). In detail, this results in a so-called pull-in effect. The movement of the sensor element 101 along the detection direction 104 toward the first electrode structure 102 is triggered by a produced electrical force which acts here between the sensor element 101 and the first electrode structure 102 due to the applied additional test voltage. This voltage is greater than the structure-related voltage

$${U}_{PullIn} ( UPI = \sqrt{\frac{4}{27} \cdot \frac{k}{ε \cdot A} \cdot {d}_{0}^{3}} and {x}_{PI} = \frac{1}{3} {d}_{0}$$

EQ. 4). In the case of a voltage U<U_{PullIn} there results a force equilibrium between the generated electrical force between the sensor element 101 and the first electrode structure 102, and in particular the repulsive or restoring force of a coupling of the sensor element 101 within the micromechanical inertial sensor, for example by means of a spring element, a new deflected position, different from the starting position, of the sensor element arises below x_{PullIn}=d₀/3 due to the force equilibrium.

The small deflection x achieved in this way can be determined experimentally and can also be solved numerically for the position x with m·x+k·x+d(x)·\dot{x}=−m·aₑₓₜ(t)+Fₛₑₜᵤₚ(U, t) EQ. 1 (↔\ddot{x}=0, \dot{x}=0) and the resulting relationship EQ. 3

$$k \cdot x = \frac{1}{2} \frac{ε \cdot \dot{A}}{{( {d}_{0} - x )}^{2}} \cdot {U}^{2}$$

implicit in x.

This does not substantially result in a comparatively large deflection, or results in only a comparatively small deflection, of the sensor element 101.

However, if the deflection occurs with a test voltage U>U_{PullIn}, then the repulsive effect of the spring 107 of the sensor element cannot compensate for the electrical forces in any position, and the sensor element 101 is moved in a shock-like manner toward the first electrode structure 102.

This results in a substantially comparatively large deflection. The region 103′ narrows suddenly, and during this the gaseous medium located in the region 103′ (between the sensor element 101 and the first electrode structure 102) is compressed in a shock-like manner. This shock-like compression of the gaseous medium results in an additional braking or damping effect being exerted on the sensor element 101 (the sensor element 101 is therefore no longer accelerated unbraked toward the first electrode structure 102). This temporarily leads to a greatly delayed movement sequence when the sensor mass approaches the stop elements 106.

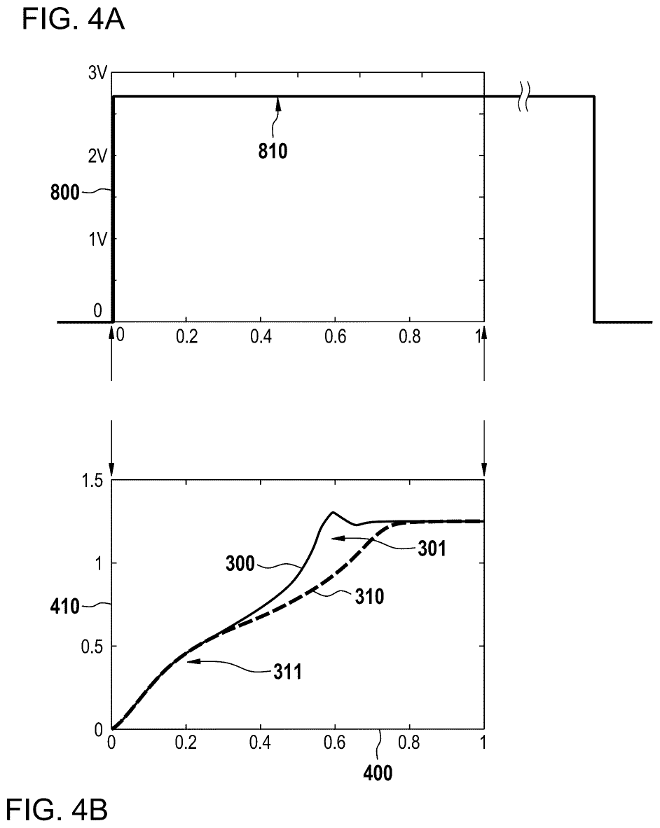

When reaching the relatively rigid stop elements 106, given weakly damping gas media, bouncing behavior of the movable sensor mass 600 or CM can occur, which can be seen in the modeling of FIG. 4B as oscillations of the curve 300. When there is stronger damping, and in particular when squeeze film effects and squeeze film repulsions form, such shock effects are strongly suppressed or are not present, as in curve 310 in FIG. 4B.

In particular, the simulation of FIG. 4B shows the above-described delay in the movement behavior when squeeze film effects develop:

The curve 300 is calculated under the assumption that no gas compression and squeeze film effect develop.

The curve 310, on the other hand, is calculated using a realistic model for squeeze film formation with respect to the damping coefficient d(x).

Both curves for the fast shock-like temporal movement sequence are calculated by means of the Newtonian differential equation of motion

$$m \cdot x = - k \cdot x - d ( x ) \cdot x + \frac{1}{2} \frac{ε \cdot \dot{A}}{{( {d}_{0} - x )}^{2}} \cdot {U ( t )}^{2}$$

EQ. 5 by numerical ODE initial value integration.

The movement sequence shown occurs in a shock-like manner, but can be measured well and precisely with a time span in the range of one millisecond.

Due to these measurable and computationally representable characteristics, information or data about the gaseous medium in the cavity and also about the comparatively large deflection can be advantageously generated.

On the one hand, characteristic values for the comparatively large deflection of the sensor element 101 itself can be effectively and efficiently derived, and on the other hand the influence of the gaseous medium can be investigated. In particular, the fast, shock-like movement sequence during pull-in is advantageous, which the coupling of increased damping d(x) due to the squeeze film formation and the high speed \dot{x} of CM during the formation of the squeeze film make the effect by multiplication (−d(x)·\dot{x}) in the differential equation of motion

$$m \cdot x = - k \cdot x - d ( x ) \cdot x + \frac{1}{2} \frac{ε \cdot \dot{A}}{{( {d}_{0} - x )}^{2}} \cdot {U ( t )}^{2}$$

EQ. 5 particularly well observable in the experiment.

The hermetic sealing of the cavity can be analyzed particularly with regard to the influence of the gaseous medium (or its absence). In the event of a leak, in particular a change in previously generated information or data can be determined. In the case of changes or deviations from previous measurements of up to one order of magnitude, a leak within the cavity can particularly preferably be identified, and thus a faulty hermetic seal can be shown to be present. Special structural defects, e.g. a breakage of damping elements with an otherwise undamaged spring-mass and electrode structure, can also be detected via the squeeze film properties of the damping elements, due to the particular sensitivity of the pull-in overload condition. Until now, it has not been possible to detect such defects using static tests or dynamic small-signal tests according to the related art.

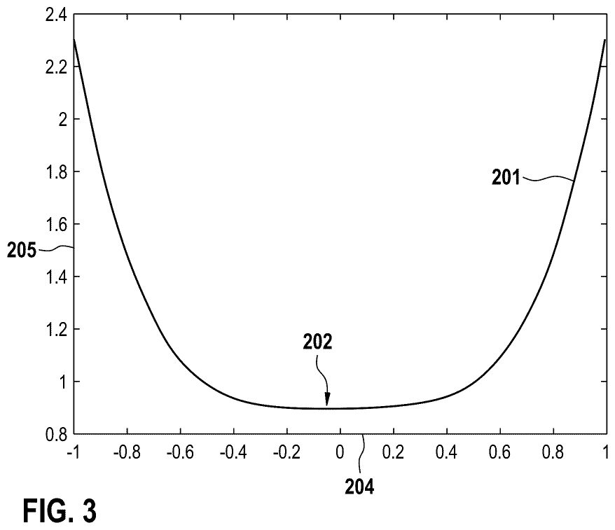

FIG. 3 shows a modeling of the influence of the gaseous medium D_{L}(x) (reference sign 205), which is located in the cavity 100, depending on a deflection x (reference sign 204) of the sensor element 101 from the starting position 105. The deflection x is given as a relative dimension relative to the achievable total deflection (700 or x=0 up to the stop element 106 in FIG. 1). The influence of the gaseous medium D_{L}(x) is modeled by a sum of a constant D_{L0} and a product of another constant a with the fourth power of the deflection x of the sensor element 101. In detail, the modeling D_{L}(x) thus results using

$${D}_{L} ( x ) = {D}_{L 0} + a \cdot {x}^{4} \qquad EQ . 6$$

For small deflections x, in the model D_{L}(x) the influence is substantially determined by a plateau 202. This substantially reflects the constant component D_{L0} in the modeling D_{L}(x), which is effective for small deflections as long as there is no increase due to squeeze film effects. For comparatively large deflections x (reference sign 201), such as those that occur for example when there are shock-like acceleration pulses in real operation or through the test situation described here due to the pull-in effect, squeeze film effects become effective and a steep rise results (i.e. large dissipative friction effects and also energetically conservative repulsive effect). This can be modeled by the influence of the fourth power of the deflection x and the other constants a. This reflects the braking or damping effect of the gaseous medium for comparatively large deflections. The empirical equation EQ. 6 is a simple modeling of the squeeze film damping effect that corresponds very well to the experimental situation. In addition, more refined models, e.g. models with additional parameters, are possible.

Furthermore, the deflection x of the sensor element 101 in the Newtonian equation of motion is determined using a modeling according to which an acceleration \ddot{x} of the sensor element 101 (in detection direction 104) is proportional to a sum of three summands (forces, force-effective accelerations), with a first summand being directly proportional to the deflection x of the sensor element 101 (in detection direction 104) (Hooke's spring), with a second summand being directly proportional to the product of the modeled influence of the gaseous medium D_{L}(x) and a speed \dot{x} of the sensor element 101 (in detection direction 104) (Stokes' law), and with a third summand describing the force effect between electrodes of the plate capacitor when the test voltage is applied. This is directly proportional to the product of the square of a modeled applied electrical voltage U(t) and the inverse of the square of a difference between the starting position dist₀ (compare reference sign 105 in FIGS. 1 and 2) of the sensor element 101 and the deflection x of the sensor element 101 (in detection direction 104). In detail, the modeling results from

$$m \cdot \ddot{x} = - k \cdot x - d ( x ) \cdot \dot{x} + \frac{1}{2} \frac{ε \cdot A}{{( {dist}_{0} - x )}^{2}} \cdot {( U ( t ) )}^{2} \qquad EQ . 5$$

$$( corresponds to m \cdot x = - k \cdot x - d ( x ) \cdot x + \frac{1}{2} \frac{ε \cdot \dot{A}}{{( {d}_{0} - x )}^{2}} \cdot {U ( t )}^{2} )$$

with m as the first constant or mass of the sensor element, k as second constant or an effective spring constant of the coupling of the sensor element 101 within the micromechanical inertial sensor, d(x) as a modeling which is directly proportional to the modeling of the influence of the gaseous medium D_{L}(x), and ½ε·A as the third constant term, or half of the product of the electrode surface A and the electric field constant ε. The directly proportional relationship between d(x) and the modeling of the influence of the gaseous medium D_{L}(x(t)) results from

$${D}_{L} ( x ( t ) ) = \frac{d ( x ( t ) )}{2 \sqrt{km}} .$$

Furthermore, with a similar intention, it is also possible to model energetically conservative (energy-conserving) squeeze film effects. The most obvious way to do this would be to correspondingly correct the Hooke spring term in

$$m \cdot x = - k \cdot x - d ( x ) \cdot x + \frac{1}{2} \frac{ε \cdot \dot{A}}{{( {d}_{0} - x )}^{2}} \cdot {U ( t )}^{2}$$

EQ. 5, e.g.: extend −k·x→−(k+k′*xⁿ)·x if experimental evidence results. Such extensions and refinements are fully consistent with the method described here and do not require any change in the analytical procedure.

However, due to the gas-dynamical fundamentals, it is initially plausible to restrict an energetically dissipative process (kinetic energy is dissipated into heat) as the largely dominant effect, which justifies a modeling according to EQ. 6.

FIGS. 4A and 4B show a temporal course 810 of the applied electrical voltage U(t) (FIG. 4A) and temporal courses 300, 310 of the deflection x of the sensor element 101 for two forms of the damping medium within the cavity (FIG. 4B, 300≙low constant damping without assumption of squeeze film formation, 310≙movement of the sensor with increasing damping with higher deflection due to the physically plausible squeeze film formation). For the calculation of the movement sequences in FIG. 4A, at t=0 the test voltage U(t) (in the above equation

$$m \cdot x = - k \cdot x - d ( x ) \cdot x + \frac{1}{2} \frac{ε \cdot \dot{A}}{{( {d}_{0} - x )}^{2}} \cdot {U ( t )}^{2}$$

EQ. 5) is switched from zero to a value U(t)=const>U_{Pullin} (reference sign 810) and is held constant. Here the time t (reference sign 400) is given in milliseconds and the voltage U(t) in volts (reference sign 800). In FIG. 4B, the time courses 300, 310 of each of the deflections x of the sensor element 101 (reference sign 410) are plotted over time t (reference sign 400). The deflections x are indicated here in micrometers and the time t is indicated in milliseconds. The time courses 300, 310 of the deflection x of the sensor element 101 can be divided into two regions 311 and 301. Within the region 311, the deflections x of the sensor element 101 are comparatively small deflections. In this region 311, the modeling of the influence of the gaseous medium D_{L}(x) is made up substantially of the plateau 202 (i.e. the influence of the gaseous medium D_{L}(x) is substantially described by the constant D_{L0}). Furthermore, the time courses 300 and 310 do not substantially differ within this region 311. The region 301 represents comparatively large deflections of the sensor element 101. For the time courses 300, 310 of the deflection x there is a difference in this region 301. The influence of the gaseous medium D_{L}(x), in this deflection range 301 and for the temporal course 310 of the deflection x, is modeled using realistically expected of the steep rise 201 (i.e., using a large repulsive effect or braking and damping effects) and for the temporal course 300 of the deflection x it is modeled exclusively taking into account the constant part D_{L0} (i.e. using the same damping effect as for small deflections).

The two curves 300 and 310 represent the limit situation of the pull-in movement sequence:
Curve 300: unrealistic assumption “no squeeze film formation”
Curve 310: realistic movement sequence with formation of squeeze film effects

Since the two curves differ in characteristic properties (occurrence/absence of bounce oscillations) and differ quantitatively in a manner that can be evaluated, the strength of the squeeze film effect can be ascertained from experimental curves by comparison with the exemplary curves 300 and 310. In the experimental procedure, for this purpose the experimental pull-in curve will be recorded and with the aid of the descriptive equations

$$m \cdot x = - k \cdot x - d ( x ) \cdot x + \frac{1}{2} \frac{ε \cdot \dot{A}}{{( {d}_{0} - x )}^{2}} \cdot {U ( t )}^{2}$$

EQ. 5 and EQ. 6, for the given sensor design model curves will be calculated corresponding to the influencing parameter a of the empirical EQ. 6. By mathematical regression (optimal curve fit) the parameter a (the “squeeze film thickness”) assigned to the sensor can then be calculated.

Furthermore, the micromechanical inertial sensor is in particular configured in such a way that the influence of the gaseous medium can be characterized using a compensation calculation based on the deflection x of the sensor element 101 and the measurement signal generated by the sensor element 101, wherein the compensation calculation is carried out in particular on the basis of the temporal behavior or course 300 of the deflection x in the region 310. Thus, in particular based on the compensation calculation and the comparison with the experimentally detected measurement signal, or the data generated therefrom, a value can be derived for the model variables D_{L0} and a. These data or information from the comparatively large of the sensor element 101 can be advantageously used to analyze the comparatively large deflections of the sensor element 101 within the cavity 100 itself, as well as to examine the hermetic sealing of the cavity 100. In particular, this information or these data can be compared with older data or information, in particular data or information generated in earlier manufacturing steps or during earlier operation of the micromechanical inertial sensor. For example, if the information or data to be compared deviate by an order of magnitude, a leak can be confirmed within the seal of the cavity 100.

What is claimed is:

1. A micromechanical inertial sensor, comprising:
a sensor element movably arranged in a cavity;
a detection device configured to detect a transient measurement signal depending on a deflection of the sensor element along a detection direction from a starting position, wherein the detection device is configured to detect comparatively small deflections and geometric full deflections of the sensor element parallel to the detection direction, wherein the detection device is further configured to effect a comparatively large mechanical deflection of the sensor element parallel to the detection direction in a test mode and includes a first electrode structure, wherein the first electrode structure is arranged opposite the sensor element along the detection direction such that a variable capacitance is formed between the sensor element and the first electrode structure and using an applied electrical voltage; and
a gaseous medium located in the cavity, the gaseous medium influencing movements of the sensor element;
wherein the micromechanical inertial sensor is configured such that the deflection of the sensor element along the detection direction can be realized using the electrical voltage such that an influence of the gaseous medium in a region between the sensor element and the first electrode structure can be detected and stored using the transient measurement signal.

2. The micromechanical inertial sensor according to claim 1, wherein the micromechanical inertial sensor is configured such that when a static voltage above a pull-in voltage is applied, the influence of the gaseous medium in the region between the sensor element and the first electrode structure and/or in a region between the sensor element and a second electrode structure, is detected using the transient measurement signal.

3. The micromechanical inertial sensor according to claim 2, wherein the influence of the gaseous medium including a damping effect, in a further region within damping structures can be detected and stored, wherein the damping structures are formed geometrically separately from the sensor element, the first electrode structure and/or the second electrode structure, wherein the damping structures are directly coupled to a movement state of the sensor sensor element.

4. The micromechanical inertial sensor according to claim 1, wherein square-wave voltages of variable pulse height can be applied as an additional test signal to a readout signal.

5. The micromechanical inertial sensor according to claim 2, wherein stop structures are positioned between the sensor element and the first electrode structure and/or between the sensor element and the second electrode structure, wherein the sensor element can be deflected at most up to a positioning of the stop structures.

6. The micromechanical inertial sensor according to claim 1, wherein the micromechanical inertial sensor is configured such that the influence of the gaseous medium can be detected by the action of a test voltage for triggering large-scale movement sequences and recording using a sensor readout principle.

7. The micromechanical inertial sensor according to claim 1, wherein the micromechanical inertial sensor is configured such that the influence of the gaseous medium can be characterized using a compensation calculation based on the deflection of the sensor element and the transient measurement signal generated and stored by the sensor element, wherein the compensation calculation is carried out based on a temporal behavior or course of the deflection, and the temporal behavior of a stored movement sequence.

8. The micromechanical inertial sensor according to claim 1, wherein a sampling rate at which the transient measurement signal is detected lies in a range far above the sensor's natural frequencies, so that a movement sequence to be characterized is not influenced by an imposed readout pattern.

9. The micromechanical inertial sensor according to claim 1, wherein the micromechanical inertial sensor is configured such that a recording of movement curves is supplemented by an additional memory.

10. A method for operating a micromechanical inertial sensor having a sensor element movably arranged in a cavity, wherein the micromechanical inertial sensor has a detection device configured to detect a measurement signal depending on a deflection of the sensor element along a detection direction from a starting position, wherein the detection device can detect comparatively small deflections up to a geometric full deflection of the sensor element parallel to the detection direction, wherein the detection device further has a comparatively large mechanical deflection of the sensor element parallel to the detection direction brought about by an additional static test voltage or a square-wave voltage via a first electrode structure, wherein the first electrode structure is arranged opposite the sensor element along the detection direction, and between the sensor element and the first electrode structure, using an applied electrical voltage, a variable capacitance is formed, wherein a gaseous medium is located in the cavity, which medium influences movements of the sensor element, the method comprising the following steps:
realizing a large deflection of the sensor element along the detection direction using a test voltage; and
detecting an influence of the gaseous medium in a region between the sensor element and the first electrode structure, using the measurement signal.
